(19) United States
(12) Patent Application Publication
(10) Pub. No.: US 2024/0005317 A1
(43) Pub. Date: Jan. 4, 2024

(54) VIRTUAL TRANSACTION MANAGEMENT

(71) Applicant: BillGO, Inc., Fort Collins, CO (US)

(72) Inventors: Kelly Seidl, Fort Collins, CO (US); Ravi Wijayasekara, Fort Collins, CO (US); Josh Rappoport, Fort Collins, CO (US)

(21) Appl. No.: 17/809,875

(22) Filed: Jun. 29, 2022

(51) Int. Cl. G06Q 20/40

(52) U.S. Cl. CPC G06Q 20/401

(57) ABSTRACT

In examples, a user computing device provides an indication to a resource manager to transfer a resource to a transaction recipient. Accordingly, the resource manager provides an indication of the transaction to a transaction platform. The transaction platform may generate or determine an alias with which to transfer the resource. The transaction platform generates transaction instructions usable by a recipient computing device to complete the transaction. The transaction platform may receive a verification request as a result of the recipient computing device executing the transaction instructions. Accordingly, the transaction platform verifies the transaction and, if the transaction is not verified successfully, user input to confirm or reject the transaction may be requested. As a result, the user need not provide potentially sensitive information to transact with the recipient and, further, is able to proactively verify transactions rather than retroactively address transaction issues.

### BACKGROUND

A transaction recipient may receive transactions according to only a subset of transaction mechanisms, such that some mechanisms that would otherwise be available (e.g., for other recipients) are not available. Additionally, it may not be possible to verify transactions performed using certain transaction mechanisms until after completion, such that issues can only be addressed retroactively.

In some instances, a transaction mechanism may typically require sensitive information about a user, such as a unique identifier, which may inadvertently expose the user to additional risk in the event that the identifier is shared with others. In general, such limitations may negatively affect a user's experience or may even cause a user to be unable to transact with a recipient in a timely manner, potentially resulting in frustration, delayed transactions, and penalties, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to virtual transaction management. In examples, a user utilizes a user computing device to provide an indication to a resource manager to transfer a resource to a transaction recipient. Accordingly, the resource manager provides an indication of the transaction to a transaction platform. The transaction platform may generate or otherwise determine an alias with which to transfer the resource. Example aliases include, but are not limited to, a unique identifier, a virtual account and/or associated account number, or a contact identifier (e.g., an email address or a telephone number). The transaction platform generates a set of transaction instructions usable by a recipient computing device to complete the transaction.

The transaction platform may receive a verification request as a result of the recipient computing device executing the transaction instructions. Accordingly, the transaction platform verifies the transaction and, if the transaction is not verified successfully, user input to confirm or reject the transaction may be requested. As a result, the user need not provide potentially sensitive information and, further, is able to proactively verify transactions rather than retroactively address transaction issues.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for virtual transaction management.

FIG. 2 illustrates an overview of an example process flow for virtual transaction management according to aspects of the present disclosure.

FIG. 3 illustrates an overview of an example method for initiating a virtual transaction according to aspects of the present disclosure.

FIG. 4 illustrates an overview of an example method for verifying a virtual transaction according to aspects of the present disclosure.

FIG. 5 illustrates an overview of an example method for maintaining a transaction agent ledger according to aspects of the present disclosure.

FIG. 6 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user transacts with a transaction recipient to transfer a resource (e.g., data, items, money or currency, etc.). A transaction platform may facilitate transactions between users and recipients using any of a variety of transaction mechanisms. However, the transaction recipient may accept only a subset of available transaction mechanisms, such that the user may be unable to transact with the transaction recipient using a transaction mechanism of choice. As an example, one transaction mechanism may be preferable over technique as a result of user preference, expediency, and/or associated fees. In some instances, an available transaction mechanism may require user information that may not otherwise be required. This user information may be sensitive, such that the user may not wish to provide the information or such that providing the information may inadvertently expose the user to additional risk in the event of a lapse in security or other disclosure.

For example, a transaction recipient (e.g., an individual or a business) may not accept payment via a credit or a debit card, and may instead accept payment via the automated clearing house (ACH) network. In order to transact via the ACH network (e.g., as a credit transfer or a direct debit), an account number or other alias of a user may be used to complete the transfer between the user and the recipient. However, such information may be sensitive and it may be preferable to transact without use of the user account number. Additionally, transactions may be completed without the potential for user interaction, such that an incorrect transaction may be noticed by a user only after the transaction has been completed. Thus, rather than proactively verifying and/or addressing incorrect transactions, a user may instead need to retroactively interact with the recipient to remedy an incorrect transaction.

Accordingly, aspects of the present disclosure relate to virtual transaction management. In examples, a transaction platform uses one or more aliases to facilitate transactions between a user and a transaction recipient. For example, the transaction platform may facilitate transactions between individuals, businesses (e.g., a service provider or a merchant), or any combination thereof, among other examples. Further, it will be appreciated that a recipient of one transaction may be a user in another transaction and, similarly, a user in one transaction may be a recipient of another transaction. As an example, a transaction may be a debit transaction or a credit transaction.

A resource manager may manage resources on behalf of a user. For example, the resource manager may manage data, assets, or any of a variety of other resources. Accordingly, a user may utilize a user computing device to provide an indication to a resource manager to send a resource to a transaction recipient, such that a transaction may occur via a transaction platform according to aspects of the present disclosure. The resource manager may communicate with the transaction platform (e.g., via an application programming interface (API) or website) to initiate the transaction. Accordingly, the transaction platform may generate an alias or, as another example, may identify a pre-existing alias (e.g., as may have been previously generated). The resource manager may provide one or more resources associated with the transaction to the transaction platform, which the transaction platform may track according to a ledger associated with the resource manager. Accordingly, when a transaction is completed, a ledger associated with the resource manager may be updated accordingly to indicate that the resource has been transferred to a recipient and is no longer associated with the resource manager.

In examples, the alias is associated with the user, the resource manager, and/or the recipient. For example, multiple aliases may be associated with a user, where each alias is associated with a different recipient. As a result, inadvertent disclosure of a user's alias (e.g., by a recipient) may not be as detrimental as the disclosure of a user's real account information (e.g., as may be associated with the user by a resource manager), as the alias may not be widely used by the user, may be easily replaced with a new alias, or may be usable only by the recipient with which the alias is associated, among other examples. Further, given the alias is used to facilitate the transaction, the recipient need not have knowledge of the user's actual information. While examples are described in which an alias is associated with a user, resource manager, and/or recipient, it will be appreciated that a different alias may be used according to any of a variety of other contexts. For example, an alias may be unique to a given transaction (e.g., such that each transaction associated with a user and/or recipient has a unique alias) and/or for a recurring transaction (e.g., such that a first recurring transaction uses a first alias and a second recurring transaction uses a second alias).

The transaction platform may generate a set of transaction instructions associated with the user's transaction. For example, the set of transaction instructions may comprise information associated with the alias discussed above. The set of transaction instructions may further comprise an indication as to the transaction platform (e.g., a transaction platform identifier or an American Bankers Association (ABA) routing transaction number (RTN) associated with the transaction platform), thereby enabling the transaction recipient to complete the transaction according to the set of transaction instructions. As another example, the transaction instructions may comprise a date by which the transaction is to be completed, a transaction amount, and/or whether the transaction is a recurring payment, among any of a variety of other instructions. It will be appreciated that each instance of a recurring transaction need not be for the same quantity, type, and/or resource. The set of transaction instructions may be provided to the recipient. For example, the transaction instructions may be provided to the recipient by the transaction platform, the resource manager, or the user. The transaction instructions may be provided via an API, a website, as an electronic communication, or as a physical communication.

Similarly, the transaction platform may automatically register or otherwise associate an alias of a user with a transaction recipient, such that the alias is usable for a subsequent transaction. For example, the transaction platform may complete a verification process on behalf of the user (e.g., by processing a transaction from the transaction recipient in association with the user's alias and providing an indication of information associated with the transaction to the transaction recipient), thereby verifying an association between the alias and the user. In examples, an indication of verification status, success, and/or failure may be provided to the user (e.g., by the transaction platform and/or the transaction recipient).

In some instances, the transaction platform operates in conjunction with a transaction agent. For example, the transaction agent may receive, store, transmit, or otherwise manage resources associated with user transactions. In an example, the transaction agent may manage a resource provided by a resource manager associated with a user transaction, such that the resource may ultimately be provided to a transaction recipient according to a set of associated transaction instructions. For instance, the transaction agent may receive an indication of a transaction as a result of a recipient completing a transaction according to the set of transaction instructions. The indication may be received from a transaction agent associated with the recipient. Example transaction agents include, but are not limited to, transaction processors and banks. While examples are described herein with respect to a transaction platform and an associated transaction agent, a transaction platform may implement such functionality in other examples, such that a separate transaction agent need not be used.

Accordingly, the transaction agent may request verification of a transaction before completing the transaction (e.g., transferring a resource to a recipient on behalf of a user). For example, an indication of the transaction may be provided to a transaction platform, such that the transaction platform may verify that the transaction conforms to the set of transaction instructions. As an example, verification is performed based at least in part on an associated recipient, transaction amount, date, and/or user. In some instances, if the transaction fails verification, an indication may be provided to the user, thereby enabling the user to confirm or reject the transaction. In other instances, an indication to reject the transaction may be automatically provided to the transaction agent without such user input. Thus, rather than retroactively addressing incorrect or unauthorized transactions, transactions performed according to aspects of the present disclosure enable proactive verification and, in some instances, user confirmation or rejection of unverified transactions.

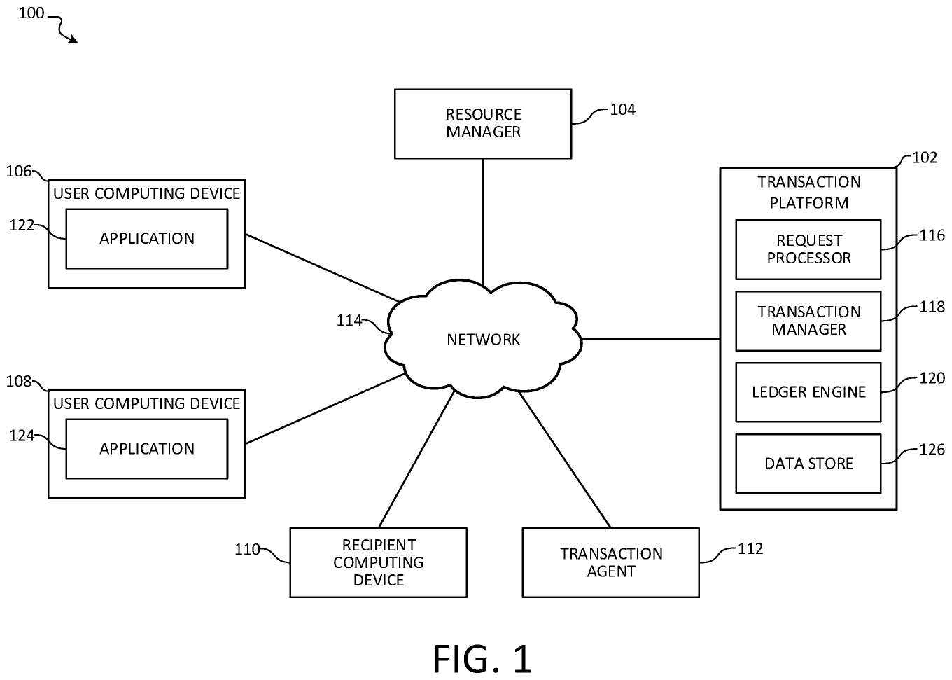

FIG. 1 illustrates an overview of an example system 100 for virtual transaction management. As illustrated, system 100 comprises transaction platform 102, resource manager 104, user computing device 106, user computing device 108, recipient computing device 110, transaction agent 112, and network 114. In examples, transaction platform 102, resource manager 104, user computing device 106, user computing device 108, recipient device 110, and transaction agent 112 communicate via network 114. For example, network 114 may comprise a local area network, a wireless network, or the Internet, or any combination thereof, among other examples. A user computing device need not be associated with a user, but may instead be associated with resource manager 104 for use by the user. As an example, resource manager 104 may operate one or more kiosks (e.g., user computing devices 106 and 108), which are available for use by a user accordingly.

User computing device 106, user computing device 108, recipient computing device 110, transaction platform 102, resource manager 104, and transaction agent 112 may each be any of a variety of computing devices, including, but not limited to, a mobile computing device, a laptop computing device, a tablet computing device, a desktop computing device, a server computing device, and/or a distributed computing device comprised of a set of computing devices that provide the functionality described herein.

It will be appreciated that while system 100 is illustrated as comprising one transaction platform 102, one resource manager 104, two user computing devices 106 and 108, one recipient computing device 110, and one transaction agent 112, any number of such elements may be used in other examples. Further, the functionality described herein may be distributed among or otherwise implemented on any number of different computing devices in any of a variety of other configurations in other examples.

As illustrated, transaction platform 102 comprises request processor 116, transaction manager 118, ledger engine 120, and data store 126. Request processor 116 processes requests, as may be received via a website or an API, among other examples. For example, request processor 116 may receive a request associated with a new user transaction, as may be received from user computing device 106, user computing device 108, and/or resource manager 104. As another example, request processor 116 may provide a set of transaction instructions (e.g., as may be generated by transaction manager 118) to recipient computing device 110 or, in a further example, may receive an indication associated with a transaction from transaction agent 112 (e.g., to verify the transaction according to aspects described herein).

Transaction manager 118 of transaction platform 102 determines an alias for a given transaction with which the transaction will be completed. For example, transaction manager 118 may generate a new alias for a transaction or may determine an existing alias. As discussed above, an alias may be associated with a user (e.g., of user computing device 106 or user computing device 108), resource manager 104, and/or a recipient (e.g., associated with recipient computing device 110). Such an association may be stored in data store 126. In other examples, an existing alias may be determined based at least in part on an association stored in data store 126.

Further, an alias need not be exclusive to a given user, resource manager, and/or recipient. For example, a first user of user computing device 106 may be associated with an alias, while a second user of user computing device 108 may also be associated with the alias. However, the alias may be used to transfer resources to different recipients or may be used to transfer resources to the same recipient at different points in time or having different amounts. In other instances, the same alias may not be used for the same recipient, as use of the same alias on behalf of multiple users may appear to be fraudulent from the perspective of the recipient. Additionally, while example associations are described, any of a variety of other associations may be used. For example, an alias may be generated on a per-transaction basis, such that an alias may only be used once for a given user/transaction pair.

As another example, transaction manager 118 generates a set of transaction instructions associated with a transaction. Example transaction instructions include, but are not limited to, information associated with a generated or determined alias, identifying information associated with transaction platform 102, a date by which the transaction is to be completed, a transaction amount and/or one or more resources associated with the transaction, a name or other identifier of the user, and/or whether the transaction is a recurring payment, among any of a variety of other instructions.

Transaction manager 118 may process a transaction based on an indication received from transaction agent 112. For example, transaction manager 118 may verify that a transaction is correct (e.g., that the transaction is associated with the correct set of resources and/or that it is for the correct amount, as well as whether the recipient is correct). If it is determined that the transaction is not correct, transaction manager 118 provides an indication to request processor 116, which communicates with user device 106 or user device 108 in order to request user input (e.g., confirmation or rejection). In other examples, transaction manager 118 automatically rejects the transaction and, in some instances, an indication of the rejected transaction is provided to user computing device 106 or 108. In instances where a transaction is verified, transaction manager 118 may update information associated with the alias to indicate that the transaction has been completed (e.g., as may be stored by data store 126).

Transaction platform 102 is illustrated as further comprising ledger engine 120. In examples, resource manager 104 provides one or more resources to transaction platform 102 on behalf of a user of user computing device 106 and/or user computing device 108. Ledger engine 120 may update a ledger associated with resource manager 104 to indicate that such resources have been received and are available to complete transactions associated therewith accordingly. As a result, when a transaction is verified successfully and transaction manager 118 updates an alias to indicate that the transaction has occurred, ledger engine 120 may further update an associated ledger (e.g., associated with resource manager 104) to indicate that the transaction has occurred. Such techniques may enable batch transactions between resource manager 104 and transaction platform 102, such that resource manager 104 need not individually provide resources for each transaction requested by user computing devices 106 and 108. Rather, resource manager 104 may provide resources periodically, thereby updating a ledger of transaction platform 102 (e.g., as may be stored 126). Accordingly, as and when transactions are completed, the associated ledger is updated accordingly.

Resource manager 104 may generate a transaction request on behalf of a user (e.g., based on an indication received from user computing device 106 or user computing device 108). In examples, resource manager 104 may manage any of a variety of resources for a user, including, but not limited to, data, items of monetary value, and/or currency. Thus, it will be appreciated that resource manager 104 may be associated with any of a variety of entities, including, but not limited to, a cloud services provider (e.g., which may manage data for a user) or a bank (e.g., which may manage assets of the user). Further, in other examples, the functionality described herein with respect to resource manager 104 may be incorporated into user computing device 106 and/or user computing device 108, such that a user need not rely on a resource manager to transact according to aspects of the present disclosure.

As discussed above, the request may be provided to transaction platform 102 via a website or API, such that it is received by request processor 116. In some instances, resource manager 104 receives an indication to generate the transaction request from application 122 or application 124 or user computing device 106 and user computing device 108, respectively. For example, applications 122 and/or 124 may be a web browser used to access a website offered by resource manager 104. As another example, applications 122 and/or 124 may be mobile applications executing on user computing devices 106 and 108, respectively. Thus, it will be appreciated that any of a variety of applications may be provided by user computing devices 106 and 108 in order to enable a user to transact according to aspects described herein.

Recipient computing device 110 is associated with a recipient of a transaction as described above. In examples, recipient computing device 110 receives a set of transaction instructions (e.g., as may be generated by transaction manager 118, as described above). Recipient computing device 110 may use the set of transaction instructions to complete the transaction. In some instances, recipient computing device may communicate with an associated transaction agent (which may be the same as transaction agent 112 or a different transaction agent).

For example, a set of transaction instructions received from transaction platform 102 may comprise an indication as to an ABA RTN and an alias of transaction platform 102, such that recipient computing device 110 initiates an ACH transfer accordingly. Accordingly, transaction agent 112 may receive an indication of the transaction. Transaction agent 112 may provide an indication to transaction platform 102 (e.g., as may be received by request processor 116), such that transaction manager 118 verifies the transaction. In instances where the transaction is not verified, an indication of the transaction may be provided to user computing device 106 or user computing device 108, such that a user may confirm or reject the transaction. In other instances, the transaction may be automatically rejected. In such instances, transaction platform 102 may instruct transaction agent 112 to reject the transaction.

By contrast, if the transaction is verified, no indication may be provided or an indication of a successful transaction may be provided. In such instances, transaction manager 118 updates the alias to reflect the resource has been transferred and, as discussed above, ledger engine 120 may update a ledger associated with resource manager 104. Transaction platform 102 may indicate to transaction agent 112 that the transaction has been verified or, in other examples, transaction agent 112 may determine the transaction has been verified as a result of not receiving a rejection from transaction platform 102 (e.g., as was discussed above).

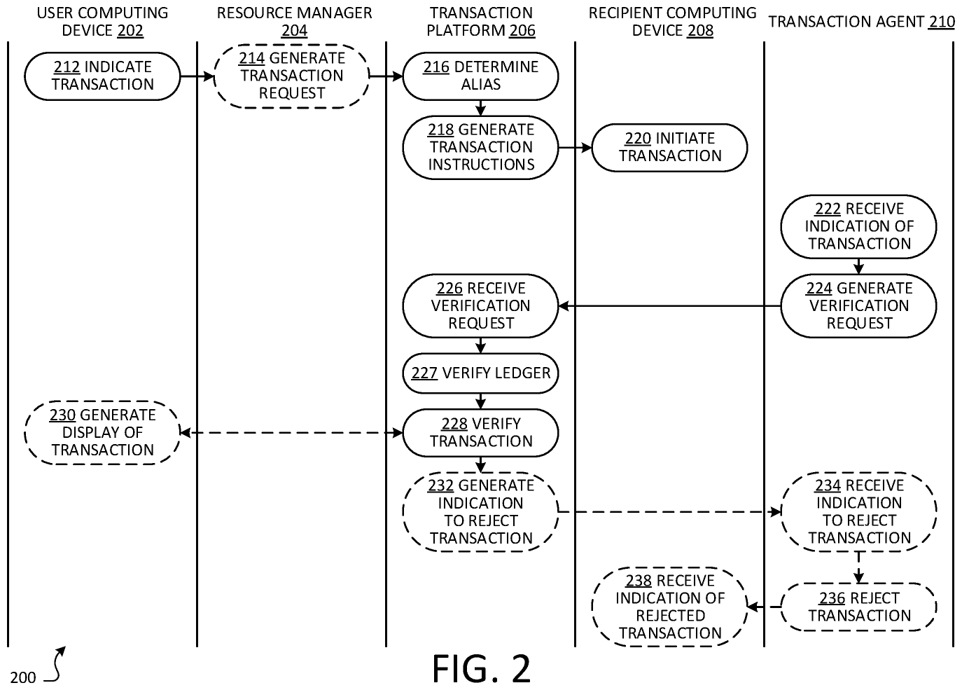

FIG. 2 illustrates an overview of an example process flow 200 for virtual transaction management according to aspects of the present disclosure. As illustrated, flow 200 occurs among user computing device 202, resource manager 204, transaction platform 206, recipient computing device 208, and transaction agent 210. In examples, user computing device 202 is similar to user computing devices 106 and 108 in FIG. 1, resource manager 204 is similar to resource manager 104, transaction platform 206 is similar to transaction platform 102, recipient computing device 208 is similar to recipient computing device 110, and transaction agent 210 is similar to transaction agent 112 discussed above with respect to FIG. 1. Accordingly, certain aspects are similar to those discussed above and may not necessarily be re-described below in detail.

Flow 200 begins at operation 212, where an indication of a transaction is generated by user computing device 202 and provided to resource manager 204. The indication may comprise any of a variety of transaction information, including, but not limited to, sender information associated with the user (e.g., a sender name or unique identifier), a recipient (e.g., a recipient name, unique identifier, account number, or other alias), a resource (e.g., data, one or more resources, and/or a transaction amount), a transaction date, and/or whether the transaction is recurring. The indication may be generated by an application, such as application 122 of user computing device 106 or application 124 of user computing device 108 discussed above with respect to FIG. 1.

Accordingly, at operation 214, resource manager 204 generates a transaction request, which is provided to transaction platform 206. In examples, the transaction request is provided to transaction platform 206 via a website or an API (e.g., as may be received by request processor 116 in FIG. 1). The transaction request may comprise at least a part of the information that was received as part of the indication discussed above with respect to operation 212. In some instances, the transaction request further comprises transferring one or more resources associated with the transaction, as may be associated with a ledger for resource manager 204 managed by transaction platform 206. In other instances, such a transfer may occur as part of a batch transaction according to aspects described herein. Operation 214 is illustrated using a dashed box to indicate that, in some examples, operation 214 may be omitted. For example, user computing device 202 may communicate directly with transaction platform 206 or a transaction request may be provided to transaction platform 206 using any of a variety of other techniques and/or devices.

At operation 216, transaction platform 206 determines an alias for the transaction. As discussed above, transaction platform 206 may determine an existing alias (e.g., based on an association with a user, recipient, and/or resource manage, among other examples) or may generate a new alias. Such aspects may be performed by a transaction manager, such as transaction manager 118 of transaction platform 102 discussed above with respect to FIG. 1.

Transaction platform 206 generates a set of transaction instructions at operation 218. As discussed above, example transaction instructions include, but are not limited to, information associated with the alias that was determined at operation 216, identifying information associated with transaction platform 206, a date by which the transaction is to be completed, a transaction amount and/or one or more resources associated with the transaction, a name or other identifier of the user (e.g., associated with user computing device 202), and/or whether the transaction is a recurring payment, among any of a variety of other instructions. In some instances, operation 218 comprises storing transaction information in association with the alias determined at operation 216, such that the transaction information may later be accessed to verify the transaction according to aspects described herein.

Recipient computing device 208 receives the transaction instructions and, at operation 220, initiates the transaction accordingly. The transaction instructions may be received by recipient computing device 208 using an API or via a website, among other examples. For example, recipient 208 may use a transaction agent to transact via the ACH network using an alias and ABA RTN indicated by the transaction instructions (e.g., as may be associated with transaction platform 206 and/or an associated transaction agent, such as transaction agent 112 in FIG. 1).

Eventually, transaction agent 210 (e.g., similar to transaction agent 112 in FIG. 1, which may be associated with transaction platform 206) receives an indication of the transaction at operation 222. For example, transaction agent 210 may receive the indication via the ACH network as a result of recipient computing device 208 performing aspects of operation 220.

At operation 224, transaction agent 210 generates a verification request, which may comprise information associated with the transaction. For example, the request may comprise information associated with recipient 208, an amount or other information relating to the resource with which the transaction is associated, and/or the user.

The verification request is received by the transaction platform at operation 226. At operation 227, transaction platform 206 verifies a ledger associated with a transaction of the verification request. For example, transaction platform 206 may determine whether one or more resources associated with the transaction have been received and are available to complete the transaction accordingly. In some instances, operation 227 may comprise determining whether and/or the extent to which the transaction may be completed even in instances where a resource has not yet been received. Such a determination may be based at least in part on a user, a transaction recipient, a resource manager, a transaction agent, and/or transaction instructions associated with the transaction.

At operation 228, transaction platform 206 verifies the transaction. In some instances, operations 227 and 228 may be performed contemporaneously or sequentially, among other examples. Verifying the transaction may comprise evaluating the transaction based at least in part on the set of transaction instructions that were generated at operation 218. Transaction platform 206 may determine the transaction instructions based on an association between an alias, a recipient, and/or a user, as may be indicated by the verification request.

As noted above, if the transaction is verified successfully at operation 228, no indication may be provided, such that transaction agent 210 automatically determines the transaction has been verified and the transaction is completed successfully. Operation 228 may comprise updating the alias to indicate the transaction was successful. As another example, operation 228 may similarly comprise updating ledger associated with resource manager 204 to indicate that one or more resources associated therewith have been transferred. In some instances, an indication of the transaction is displayed by user computing device 202 at operation 230. Operation 230 is illustrated using a dashed box to show that, in other instances, operation 230 may be omitted.

In instances where the transaction is not verified successfully, operation 230 may comprise generating an indication that the transaction was not verified successfully. For example, the indication may comprise an expected amount versus an actual amount, or any of a variety of other differences that may have caused the transaction to fail verification. In some instances, operation 230 comprises requesting user input to either confirm or reject the transaction, which may be received by transaction platform 206.

Accordingly, at operation 232, an indication to reject the transaction is generated, which is received by transaction agent 210 at operation 234. For example, the indication may be generated in response to receiving an indication from user computing device 202 to reject the transaction or, as another example, may be generated automatically. Such behavior may be user-configurable. The indication to reject the transaction may comprise an indication as to why the transaction was rejected, such as an ACH return code.

At operation 236, transaction agent 210 rejects the transaction. For example, rejecting the transaction may comprise providing a predetermined error code to recipient computing device 208 (or, in other examples, to a transaction agent with which recipient computing device 208 is associated), which is received at operation 238. Operations 230-238 are illustrated using dashed lines to indicate that, in some examples (e.g., when a transaction is successfully verified), they may be omitted.

Thus, aspects described herein enable transactions between a user and a recipient without providing sensitive information, such as a user's actual account number. Rather, an alias is determined by transaction platform 206 (e.g., as discussed above with respect to operation 216), which is then used to transact accordingly. Additionally, the transaction is verified (e.g., operations 230), such that an incorrect transaction may be accepted or rejected proactively (e.g., operations 230-238). Such aspects may be preferable as compared to instances where a user retroactively addresses issues, which may cause resources of a resource manager to be overdrawn.

Process flow 200 is provided as an example of virtual transaction management. It will be appreciated that similar techniques may be applied in instances where there are recurring transactions similar to the transaction described above. For example, transaction platform 206 may perform aspects similar to operation 218 to process transactions on a recurring basis, such that transaction instructions are provided to recipient computing device 208 for each recurring transaction (e.g., absent subsequent transaction indications from user computing device 202 resulting from operation 212). In other examples, the transaction instructions generated by transaction platform 206 may cause the transaction recipient to initiate transactions on a recurring basis (e.g., similar to operation 220). Thus, it will be appreciated that similar techniques may be applied for single transactions and recurring transactions, among other examples.

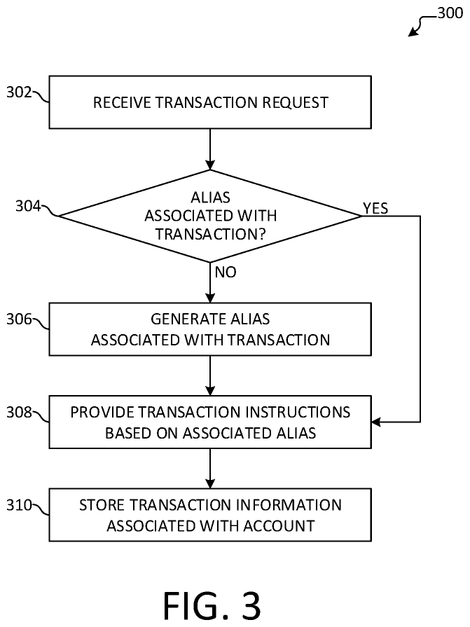

FIG. 3 illustrates an overview of an example method 300 for initiating a virtual transaction according to aspects of the present disclosure. Aspects of method 300 may be performed by a transaction platform such as transaction platform 102 in FIG. 1 or transaction platform 206 in FIG. 2.

Method 300 begins at operation 302, where a transaction request is received. For example, the transaction request may be received from a resource manager, such as resource manager 104 in FIG. 1 or resource manager 204 in FIG. 2. As discussed above, the request may be received via a website or an API, as may be received by a request processor, such as request processor 116 of transaction platform 102 in FIG. 1. The transaction request may comprise any of a variety of transaction information, including, but not limited to, sender information associated with the user (e.g., a sender name or unique identifier), a recipient (e.g., a recipient name, unique identifier, account number, or other alias), a resource (e.g., data, one or more resources, and/or a transaction amount), a transaction date, and/or whether the transaction is recurring.

Flow progresses to determination 304, where it is determined whether there is an alias associated with the transaction. In examples, aspects of determination 304 may be performed by a transaction manager, such as transaction manager 118 discussed above with respect to FIG. 1. The determination may comprise accessing a data store (e.g., data store 126 in FIG. 1) to determine whether there is an alias associated with the user, recipient, and/or resource manager associated with the transaction. As discussed above, any of a variety of aliases may be associated with a user, such as a virtual account of a transaction platform. While example associations are described herein, it will be appreciated that any of a variety of additional or alternative associations may be used.

If it is determined that there is not an alias associated with the transaction, flow branches “NO” to operation 306, where an alias is generated and associated with the transaction. In instances where the alias is a virtual account, generating the alias may comprise determining an account number from a set of available account numbers and generating an association with which to identify the alias in the future. Flow progresses to operation 308, which is discussed below.

If, however, it is determined that there is an alias associated with the transaction (e.g., as may be determined based on an association, as discussed above), flow instead branches “YES” to operation 308, where transaction instructions associated with the alias are provided. As discussed above, example transaction instructions include, but are not limited to, information associated with the alias that was determined at determination 304, identifying information associated with the transaction platform, a date by which the transaction is to be completed, a transaction amount and/or one or more resources associated with the transaction, a name or other identifier of the user, and/or whether the transaction is a recurring payment, among any of a variety of other instructions. The transaction instructions may be provided to a recipient computing device of a recipient, such as recipient computing device 110 in FIG. 1 or recipient computing device 208 in FIG. 2.

Flow progresses to operation 310, where transaction information associated with the alias is stored. For example, the transaction information may be stored in a data store, such as data store 126 in FIG. 1. The transaction information may be used to verify the transaction, according to aspects described herein. In some examples, operation 310 comprises associating a resource with the alias, such that the resource may subsequently be transferred. A ledger (e.g., as may be associated with a resource manager) may similarly be updated to reflect the associated resource, such that the associated resource may be received from the resource manager as described above. Method 300 terminates at operation 310.

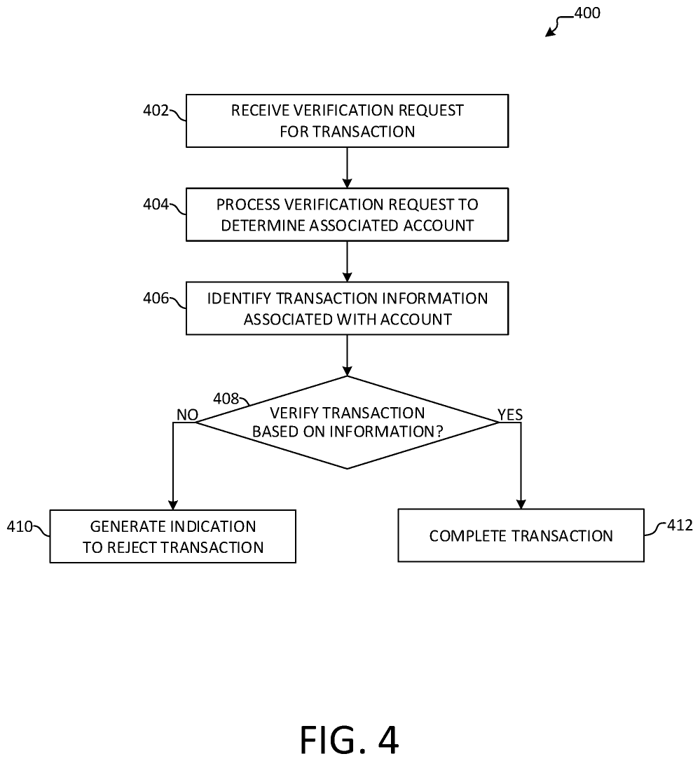

FIG. 4 illustrates an overview of an example method 400 for verifying a virtual transaction according to aspects of the present disclosure. In examples, aspects of method 400 are performed by a transaction platform, such as transaction platform 102 in FIG. 1 or transaction platform 206 in FIG. 2.

Method 400 begins at operation 402, where a verification request for a transaction is received. For example, the verification request may be received from a transaction agent, such as transaction agent 112 in FIG. 1 or transaction agent 210 in FIG. 2. The verification request may be received via an API or a website, among other examples. As discussed above, the verification request may comprise information associated with the transaction, including, but not limited to, an associated user (e.g., or sender), a recipient, a resource manager, one or more associated resources (e.g., data or a transaction amount), a transaction date, and/or an indication as to the transaction platform.

Flow progresses to operation 404, where the verification request is processed to determine an associated alias. For example, the information that was received at operation 402 may be used to identify an association between a user, recipient, resource manager, and/or resource indicated therein and an alias. The association may be identified in a data store, such as data store 126 in FIG. 1. It will be appreciated that an association may exist between the alias and any of a variety of alternative or additional information.

At operation 406, transaction information associated with the alias is identified. For example, the transaction information may be stored in the data store (e.g., data store 126 in FIG. 1). Example transaction information includes, but is not limited to, sender information associated with the user (e.g., a sender name or unique identifier), a recipient (e.g., a recipient name, unique identifier, account number, or other alias), a resource (e.g., data, one or more resources, and/or a transaction amount), a transaction date, and/or whether the transaction is recurring.

At determination 408, it is determined whether the transaction can be verified based on the identified transaction information. For example, determination 408 may comprise comparing a recipient indicated by the verification request and a recipient indicated by the identified transaction information. Alternative or additional comparisons include, but are not limited to, a date indicated by the request and a date indicated by the transaction information, a resource indicated by the request and a resource indicated by the transaction information, and/or a sender indicated by the request and a sender indicated by the transaction information, among other examples. As another example, determination 408 may include verifying a ledger (e.g., similar to aspects discussed above with respect to operation 227 of FIG. 2). In some instances, determination 408 further comprises requesting and subsequently receiving user input at a user computing device to confirm or reject the transaction when it is determined that the transaction cannot be verified based on the transaction information. Such aspects are similar to those discussed with respect to operations 228 and 230 of FIG. 2. For example, if the user confirms the transaction, it may be determined that the transaction is verified.

If it is determined that the transaction cannot be verified, flow branches “NO” to operation 410, where an indication to reject the transaction is generated. For example, the indication may be provided to the transaction agent from which the verification request was received at operation 402. Flow terminates at operation 410. As another example, an indication may be provided via the National Automated Clearing House Association (NACHA), via The Clearing House (TCH) Real-Time Payments (RTP) network, or using an API call, among other examples.

If, however, it is determined that the transaction is verified, flow instead branches “YES” to operation 412, where the transaction is completed. For example, aspects of operation 412 may comprise updating the alias associated with the transaction to indicate the transaction was successful. As another example, a ledger associated with a resource manager may be updated to indicate that one or more resources associated therewith have been transferred. In some instances, operation 412 comprises providing an indication to a user computing device that the transaction was completed successfully and/or providing an indication to the transaction platform that verification as successful. Flow terminates at operation 412.

Method 400 is described as an example where an indication may be provided in instances where a transaction is not verified and is therefore rejected, while an indication of a completed transaction may not be provided. It will be appreciated that any of a variety of alternative techniques may be used, for example where an indication is provided when a transaction is successfully verified but not provided when a transaction is not verified. As another example, both operations 410 and 412 may comprise providing indications accordingly.

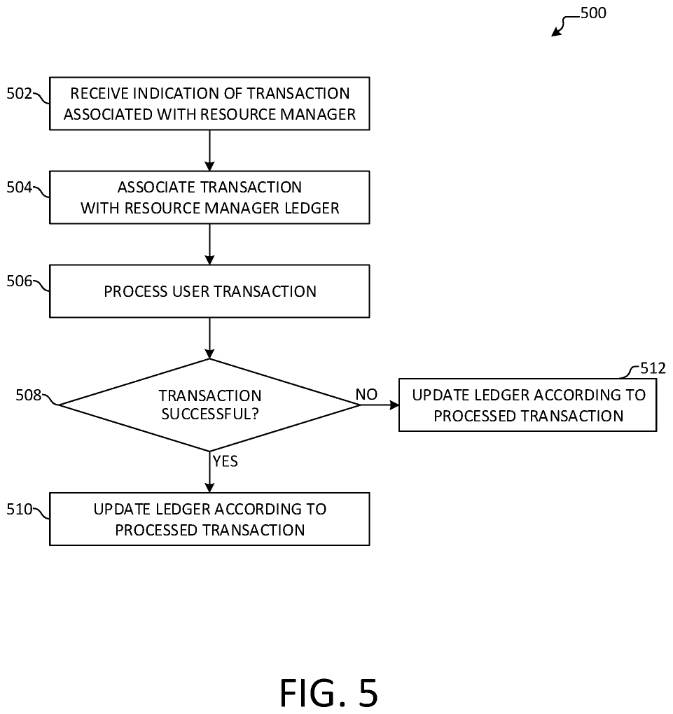

FIG. 5 illustrates an overview of an example method 500 for maintaining a transaction agent ledger according to aspects of the present disclosure. In examples, aspects of method 500 are performed by a transaction platform, such as transaction platform 102 in FIG. 1 or transaction platform 206 in FIG. 2.

Method 500 begins at operation 502, where an indication of a transaction associated with a resource manager is received. For example, the indication may be a transaction request generated by resource manager 204 performing aspects of operation 214, as were described above with respect to FIG. 2. In some examples, the indication further comprises a transfer of one or more resources associated with the transaction, such that the resource manager provides such resources to the transaction platform for ultimate transfer to a transaction recipient.

Flow progresses to operation 504, where the transaction is associated with a resource manager ledger. Such aspects may be performed by a ledger engine, such as ledger engine 120 discussed above with respect to FIG. 1. Thus, a transaction platform may manage multiple ledgers, such that a resource manager may have one or more associated ledgers. In other examples, a ledger may be associated with a user or, as another example, a ledger may not be used such that various aspects of operation 504 may be omitted. As an example, operation 504 may additionally or alternatively comprise evaluating historical information relating to the transaction to determine an associated risk. Example historical information includes, but is not limited to, as payment history, a tenure with the product, and/or a user's history, among other information.

While aspects described herein are discussed in instances where a resource is transferred contemporaneously with an indication of an associated transaction, it will be appreciated that a resource may be transferred at any of a variety of times, such as before or after the transaction is received. For example, resource transfers may be batched, where resources associated with multiple transactions are transferred by a resource manager to a transaction platform, even though associated transaction indications may have been provided before, during, and/or after such a batch transfer.

At operation 506, a user transaction is processed. For example, operation 506 may comprise performing aspects of operations 226, 228, and 232 discussed above with respect to FIG. 2 and/or aspects of method 400 discussed above with respect to FIG. 4.

Flow progresses to determination 508, where it is determined whether the transaction was successful. For example, aspects of determination 508 may be similar to those of determination 408 discussed above with respect to FIG. 4. As an example, if the transaction is verified according to transaction information and/or confirmed by a user via a user computing device, it may be determined that the transaction was successful. If it is determined that the transaction was not successful, flow branches “NO,” where the ledger associated with the resource manager is updated to reflect that the transaction was not completed successfully. For example, the ledger may be updated to reflect that a resource remains with a resource manager and/or information associated with why the transaction did not complete. As another example, operation 512 may be omitted such that method 500 terminates as a result of determining that the transaction was not successful. As illustrated, method 500 ends at operation 512. In some instances, operations 508, 510, and/or 512 may be omitted, such that a transaction that is processed at operation 506 is assumed to succeed. Thus, it will be appreciated that any of a variety of techniques may be used to process transactions according to aspects described herein.

However, if it is instead determined that the transaction was successful, flow branches “YES” to operation 510, where the ledger associated with the resource manager is updated to reflect that the transaction was completed successfully. For example, the resource manager ledger may be updated to reflect that the resource received from the resource manager has since been transferred to the recipient. In other examples, the ledger may be updated to indicate that the resource has not yet been received from the resource manager, such that the resource manager may provide the resource. Thus, it will be appreciated that a resource manager need not provide a resource prior to transaction completion and that, in other examples, a resource associated with a transaction may be received from a resource manager after completion. Flow terminates at operation 510.

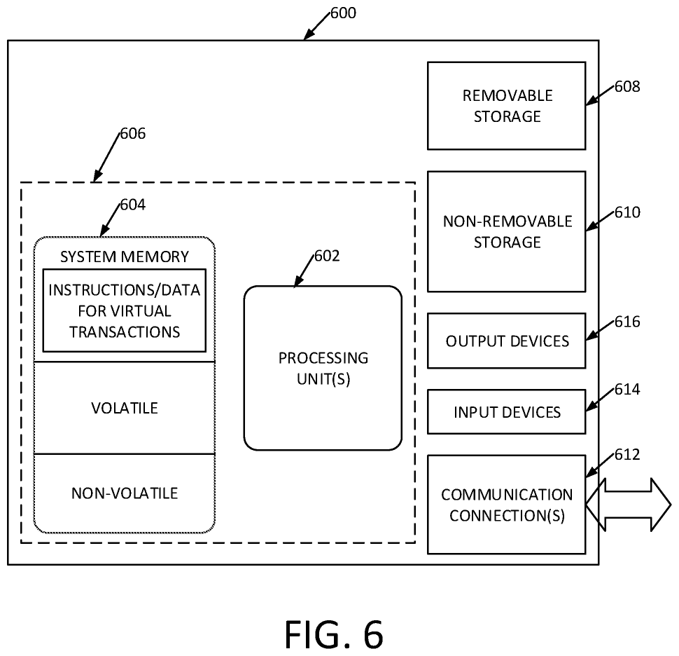

FIG. 6 illustrates an example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically may include at least one processing unit 602 and memory 604. Depending on the exact configuration and type of computing device, memory 604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as a keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 may include at least some form of computer readable media. The computer readable media may be any available media that can be accessed by processing unit 602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 604. While executing on the processing unit 602, program modules (e.g., applications, Input/Output (I/O) management, and other utilities) may perform processes including, but not limited to, one or more of the stages of the operational methods described herein such as the methods illustrated in FIG. 2, 3, 4, or 5, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: receiving a transaction request associated with a user, wherein the transaction request comprises an indication of a recipient of a transaction; determining an alias associated with the user; generating a set of transaction instructions comprising an indication of the determined alias; providing the set of transaction instructions to a computing device of the transaction recipient; receiving a transaction verification request; processing the transaction verification request to determine whether to confirm the transaction; and when it is determined not to confirm the transaction, providing, in response to the received transaction verification request, an indication to reject the transaction. In an example, determining the alias associated with the user comprises: accessing a data store to determine whether an alias is associated with the user; and when it is determined that an alias is not associated with the user: generating the alias; and associating the alias with the user in the data store. In another example, the alias associated with the user is further determined based at least in part on an association of the alias with the transaction recipient. In a further example, the set of operations further comprises: receiving, from a resource manager, a resource associated with the transaction; updating, in a data store, a ledger associated with the resource manager to indicate the received resource; and when it is determined to confirm the transaction, updating the ledger to indicate the resource was transferred to the transaction recipient. In yet another example, processing the transaction verification request further comprises: providing, to a user computing device, a request to confirm the transaction when the transaction verification request is not verified; and receiving, in response to the request to confirm the transaction, an indication to reject the transaction. In a further still example, the set of transaction instructions further comprises a routing transaction number associated with the alias. In another example, the transaction verification request is received from a transaction agent associated with the routing transaction number.

In another aspect, the technology relates to a method for processing a transaction using an alias. The method comprises: receiving, from a resource manager, a transaction request associated with a user comprising an indication of a recipient of a transaction, wherein the transaction is to transfer a resource of the resource manager to the transaction recipient; determining an alias associated with the user; generating a set of transaction instructions comprising an indication of the determined alias and an associated routing transaction number; and providing the set of transaction instructions to a computing device of the transaction recipient. In an example, the method further comprises: receiving, from a transaction agent associated with the routing transaction number, a transaction verification request; processing the transaction verification request to determine whether to confirm the transaction; and when it is determined not to confirm the transaction, providing, in response to the received transaction verification request, an indication to reject the transaction. In another example, processing the transaction verification request further comprises: providing, to a user computing device, a request to confirm the transaction when the transaction verification request is not verified; and receiving, in response to the request to confirm the transaction, an indication to reject the transaction. In a further example, the method further comprises: receiving, from a transaction agent associated with the routing transaction number, a transaction verification request; processing the transaction verification request to determine whether to confirm the transaction; and when it is determined to confirm the transaction, providing an indication to a user computing device that the transaction is confirmed. In yet another example, determining the alias associated with the user comprises: accessing a data store to determine whether an alias is associated with the user; and when it is determined that an alias is not associated with the user: generating the alias; and associating the alias with the user in the data store. In a further still example, the alias associated with the user is further determined based at least in part on an association of the alias with the transaction recipient. In another example, the method further comprises: receiving, from the resource manager, the resource associated with the transaction; updating a ledger associated with the resource manager to indicate the received resource; and when it is determined to confirm the transaction, updating the ledger to indicate the resource was transferred to the transaction recipient.

In a further aspect, the technology relates to a method for processing a transaction using an alias. The method comprises: receiving, from a resource manager: a transaction request associated with a user, wherein the transaction request comprises an indication of a recipient of a transaction; and the resource associated with the transaction; updating a ledger associated with the resource manager to indicate the received resource; determining an alias associated with the user; generating a set of transaction instructions comprising an indication of the determined alias; providing the set of transaction instructions to a computing device of the transaction recipient; receiving a transaction verification request; processing the transaction verification request to determine whether to confirm the transaction; and when it is determined to confirm the transaction, updating the ledger to indicate the resource was transferred to the transaction recipient. In an example, determining the alias associated with the user comprises: accessing a data store to determine whether an alias is associated with the user; and when it is determined that an alias is not associated with the user: generating the alias; and associating the alias with the user in the data store. In another example, the alias associated with the user is further determined based at least in part on an association of the alias with the transaction recipient. In a further example, processing the transaction verification request to determine whether to confirm the transaction comprises: determining that the transaction is not verified; and based on determining that the transaction is not verified: providing, to a user computing device, a request to confirm the transaction; and receiving, in response to the request to confirm the transaction, an indication to confirm the transaction. In yet another example, the set of transaction instructions further comprises a routing transaction number associated with the alias. In a further still example, the transaction verification request is received from a transaction agent associated with the routing transaction number.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving a transaction request associated with a user, wherein the transaction request comprises an indication of a recipient of a transaction;
determining an alias associated with the user;
generating a set of transaction instructions comprising an indication of the determined alias;
providing the set of transaction instructions to a computing device of the transaction recipient;
receiving a transaction verification request;
processing the transaction verification request to determine whether to confirm the transaction; and
when it is determined not to confirm the transaction, providing, in response to the received transaction verification request, an indication to reject the transaction.

2. The system of claim 1, wherein determining the alias associated with the user comprises:
accessing a data store to determine whether an alias is associated with the user; and
when it is determined that an alias is not associated with the user:
generating the alias; and
associating the alias with the user in the data store.

3. The system of claim 1, wherein the alias associated with the user is further determined based at least in part on an association of the alias with the transaction recipient.

4. The system of claim 1, wherein the set of operations further comprises:
receiving, from a resource manager, a resource associated with the transaction;
updating, in a data store, a ledger associated with the resource manager to indicate the received resource; and
when it is determined to confirm the transaction, updating the ledger to indicate the resource was transferred to the transaction recipient.

5. The system of claim 1, wherein processing the transaction verification request further comprises:
providing, to a user computing device, a request to confirm the transaction when the transaction verification request is not verified; and
receiving, in response to the request to confirm the transaction, an indication to reject the transaction.

6. The system of claim 1, wherein the set of transaction instructions further comprises a routing transaction number associated with the alias.

7. The system of claim 6, wherein the transaction verification request is received from a transaction agent associated with the routing transaction number.

8. A method for processing a transaction using an alias, comprising:
receiving, from a resource manager, a transaction request associated with a user comprising an indication of a recipient of a transaction, wherein the transaction is to transfer a resource of the resource manager to the transaction recipient;
determining an alias associated with the user;
generating a set of transaction instructions comprising an indication of the determined alias and an associated routing transaction number; and
providing the set of transaction instructions to a computing device of the transaction recipient.

9. The method of claim 8, further comprising:
receiving, from a transaction agent associated with the routing transaction number, a transaction verification request;
processing the transaction verification request to determine whether to confirm the transaction; and
when it is determined not to confirm the transaction, providing, in response to the received transaction verification request, an indication to reject the transaction.

10. The method of claim 9, wherein processing the transaction verification request further comprises:
providing, to a user computing device, a request to confirm the transaction when the transaction verification request is not verified; and
receiving, in response to the request to confirm the transaction, an indication to reject the transaction.

11. The method of claim 8, further comprising:
receiving, from a transaction agent associated with the routing transaction number, a transaction verification request;
processing the transaction verification request to determine whether to confirm the transaction; and
when it is determined to confirm the transaction, providing an indication to a user computing device that the transaction is confirmed.

12. The method of claim 8, wherein determining the alias associated with the user comprises:
accessing a data store to determine whether an alias is associated with the user; and
when it is determined that an alias is not associated with the user:
generating the alias; and
associating the alias with the user in the data store.

13. The method of claim 12, wherein the alias associated with the user is further determined based at least in part on an association of the alias with the transaction recipient.

14. The method of claim 8, further comprising:
receiving, from the resource manager, the resource associated with the transaction;
updating a ledger associated with the resource manager to indicate the received resource; and
when it is determined to confirm the transaction, updating the ledger to indicate the resource was transferred to the transaction recipient.

15. A method for processing a transaction using an alias, comprising:
receiving, from a resource manager:
a transaction request associated with a user, wherein the transaction request comprises an indication of a recipient of a transaction; and
the resource associated with the transaction;
updating a ledger associated with the resource manager to indicate the received resource;
determining an alias associated with the user;
generating a set of transaction instructions comprising an indication of the determined alias;
providing the set of transaction instructions to a computing device of the transaction recipient;
receiving a transaction verification request;
processing the transaction verification request to determine whether to confirm the transaction; and
when it is determined to confirm the transaction, updating the ledger to indicate the resource was transferred to the transaction recipient.

16. The method of claim 15, wherein determining the alias associated with the user comprises:
accessing a data store to determine whether an alias is associated with the user; and
when it is determined that an alias is not associated with the user:
generating the alias; and
associating the alias with the user in the data store.

17. The method of claim 15, wherein the alias associated with the user is further determined based at least in part on an association of the alias with the transaction recipient.

18. The method of claim 15, wherein processing the transaction verification request to determine whether to confirm the transaction comprises:
determining that the transaction is not verified; and
based on determining that the transaction is not verified:
providing, to a user computing device, a request to confirm the transaction; and
receiving, in response to the request to confirm the transaction, an indication to confirm the transaction.

19. The method of claim 15, wherein the set of transaction instructions further comprises a routing transaction number associated with the alias.

20. The method of claim 19, wherein the transaction verification request is received from a transaction agent associated with the routing transaction number.
